(19) United States
(12) Patent Application Publication
(10) Pub. No.: US 2026/0107085 A1
(43) Pub. Date: Apr. 16, 2026

(54) EARPHONE AND METHOD OF USE

(71) Applicant: The Regents of the University of Michigan, Ann Arbor, MI (US)

(72) Inventors: Dhruv Jain, Ann Arbor, MI (US); Hanlong Liu, Ann Arbor, MI (US)

(21) Appl. No.: 19/355,355

(22) Filed: Oct. 10, 2025

Related U.S. Application Data
(60) Provisional application No. 63/706,317, filed on Oct. 11, 2024.

(51) Int. Cl. H04R 1/24; H04R 1/10; H04R 1/28; H04R 9/06; H04R 11/02; H04R 19/02

(52) U.S. Cl. CPC H04R 1/24; H04R 1/1016; H04R 1/1075; H04R 1/2811; H04R 9/06; H04R 11/02; H04R 19/02; H04R 2460/13

(57) ABSTRACT

An earphone and method of use involve transferring vibrations from a bone conduction speaker to an outer shell, and then transferring vibration from the outer shell directly to a concha of a user's ear. The vibratory effect can be amplified via both air conduction and cavity resonance through a bone conduction shell body portion. In one implementation, the bone conduction speaker is located adjacent a concha contour surface in the outer shell. In another implementation, an electrostatic speaker is located at least partially within the outer shell, a dynamic speaker is located at least partially within the outer shell, and a plurality of balanced armature speakers are located at least partially within the shell.

### FIELD

This invention relates generally to auditory technologies, and more particularly, to earphones and methods of use.

### BACKGROUND

Current earphones on the market are oftentimes uncomfortable, lack customization options, and have inferior performance attributes, particularly in view of cost. Most currently available earphones on the market are designed with a single type of speaker. Dynamic speakers are typically used in consumer-grade earphones, while balanced armature speakers are generally used in hearing aids and devices for the deaf and hard of hearing. Occasionally, an earphone may have both a balanced armature and dynamic speaker, but without a bone conduction or electrostatic speaker. Use of the speaker types described herein can help improve quality, while maintaining a small, conformational outer package.

Additionally, integration of more speaker types within a smaller package can be challenging, particularly with respect to bone conduction, which is usually incorporated in an ear-hook structure outside of the ear or must be fully inserted into the ear canal. The earphones described herein may be used by general consumers who would like a better fit and performance, as well as professionals such as singers, recording studio personnel, and band members, particularly those in view of the pursuit of sound quality and looking to experience an immersive musical feast. The earphones may also be particularly useful for noise reduction and isolation, thus useful to those sensitive to outside noise or in noisy environments such as public transportation, open office spaces, etc. The earphones may also be beneficial to users who prioritize comfort, such as people with sensitive ears or those who use earphones for long hours of work or travel.

### SUMMARY

In accordance with one embodiment, there is provided an earphone comprising an outer shell having a concha contour surface and a bone conduction speaker located at least partially in the outer shell. The bone conduction speaker is located adjacent the concha contour surface.

In some embodiments, the earphone further comprises an electrostatic speaker, a dynamic speaker, and a balanced armature speaker. Each of the bone conduction speaker, the electrostatic speaker, the dynamic speaker, and the balanced armature speaker can be located wholly within the outer shell.

In some embodiments, the outer shell has an outer shell body extending from an insertion end to an outer end. The outer shell body can have an inner component retaining wall that leads to a speaker recess base surface. The speaker recess base surface is located along an offset plane from a plane defined by the outer shell at the outer end of the outer shell body.

In some embodiments, the outer shell body has a bone conduction shell body portion that extends from the speaker recess base surface. The bone conduction shell body portion comprises a side wall that at least partially surrounds the bone conduction speaker. The bone conduction shell body portion has a base wall adjoining the side wall. The side wall is an annular side wall that can have a height that is less than a height of the bone conduction speaker. The base wall can be a continuous vibratory surface.

In accordance with some embodiments, there is provided an earphone comprising an outer shell, an electrostatic speaker located at least partially within the outer shell, a dynamic speaker located at least partially within the outer shell, and a plurality of balanced armature speakers located at least partially within the outer shell.

In some embodiments, the earphone further comprises a bone conduction speaker located at least partially within the outer shell. The bone conduction speaker is located adjacent a concha contour surface in the outer shell. Also, two or more balanced armature speakers of the plurality of balanced armature speakers can cooperate with a single transmission channel.

In accordance with yet another embodiment, there is provided a method of using an earphone. The earphone comprises a bone conduction speaker located at least partially within an outer shell. The method includes transferring vibration from the bone conduction speaker to the outer shell, and transferring vibration from the outer shell to a concha of a user.

In some embodiments, the bone conduction speaker is located at least partially within a bone conduction shell body portion to amplify a vibratory effect during either of the transferring vibration steps. The vibratory effect is amplified through both air conduction and cavity resonance through the outer shell.

It is contemplated that any number of the individual features of the above-described embodiments and of any other embodiments depicted in the drawings or description below can be combined in any combination to define an invention, except where features are incompatible.

### BRIEF DESCRIPTION OF DRAWINGS

Example embodiments will hereinafter be described in conjunction with the appended drawings, wherein like designations denote like elements, and wherein:

FIG. 1 is a perspective view of an earphone from the insertion end;

FIG. 2 is a perspective view of the earphone of FIG. 1 from the outer end, opposite the insertion end;

FIG. 3 shows part of the outer shell body that is used with the earphone of FIGS. 1 and 2;

FIG. 4 shows the outer shell that can be used with the earphone of FIGS. 1-3;

FIG. 5 shows an earphone of the embodiments illustrated in FIGS. 1-4, inserted into a user's ear;

FIG. 6 is a perspective view of another embodiment of an earphone from the insertion end;

FIG. 7 is a perspective view of the earphone of FIG. 6 from the outer end, opposite the insertion end; and

FIG. 8 shows interaction of the outer shell with a user's ear for the earphone of FIGS. 1-3.

### DESCRIPTION

The earphones described herein help optimize bone conduction auditory transmission compared to current devices, while being enclosed in an outer shell that promotes a conformational and comfortable fit. In some embodiments, the shell may be 3D printed, allowing for customization of the earphones'structure to fit the user's ears better. This results in a more comfortable wearing experience, reducing pressure points and fatigue, and making the earphones more comfortable to wear for extended periods. The earphone's snug fit to the human ear enormously improves its noise canceling ability and noise isolation capability. Moreover, the earphones described herein have improved sound quality, at least partially due to the integration of multiple speaker/driver types within a single earphone. This can lead to a more immersive listening experience with better bass, clarity, and balance. Additionally, the multi-speaker structure allows the earphones to respond to a faster frequency range and a broader frequency response curve.

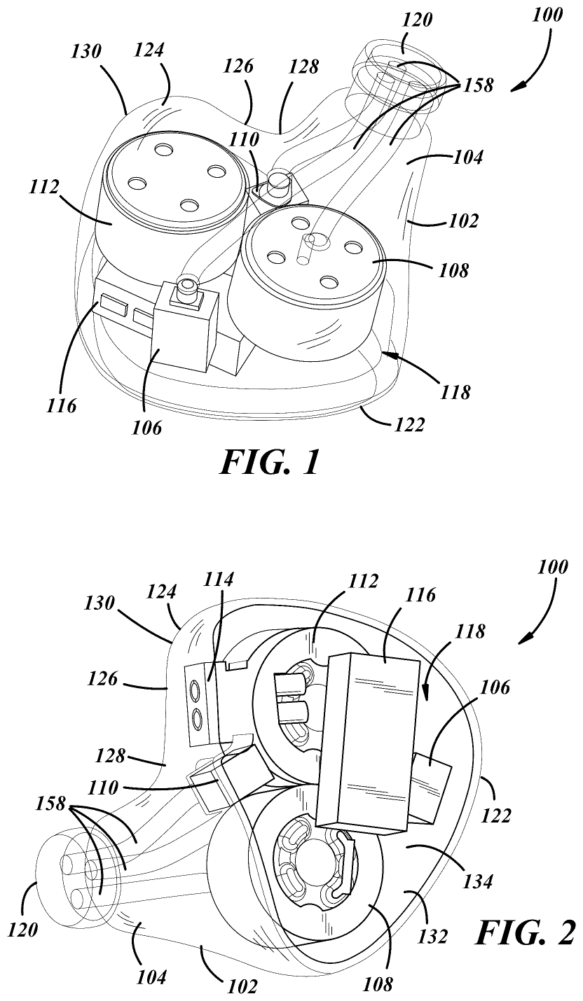

FIGS. 1 and 2 show an earphone 100 according to one embodiment (also known as a headphone). The earphone 100 has an outer shell 102, which in this implementation, has a variable thickness outer shell body 104 that is particularly configured to strategically house the various internal subcomponents of the earphone. The earphone 100 advantageously comes with another, typically identical, earphone for use with both of a user's ears. One or more of the earphones 100 are configured to interface with external audio sources, ensuring that sound signals can be effectively transmitted to the internal audio subcomponents of the earphone. This connection may be wired, wireless, or a combination, as detailed further below.

In the illustrated embodiment, the earphone 100 integrates a balanced armature speaker 106, a dynamic speaker 108, an electrostatic speaker 110, and a bone conduction speaker 112. As detailed further herein, this multi-speaker integration is challenging while maintaining a smaller size for the earphone 100, but strategic integration of these speakers within the outer shell 102 can strategically improve sound quality. In one implementation, the speakers 106, 108, 110, and 112 are configured to work simultaneously to produce sound. Additionally, as detailed further herein, the speakers 106, 108, 110, 112 are particularly configured within the shell body 104 to optimize both cavity vibration and air conduction, which can provide users with a more stereoscopic and dynamic audio experience than other multi-unit speaker earphones. Other internal subcomponents are certainly possible, such as the signal interface 114, one or more transformers 116, filters, other speaker types, etc.

The balanced armature speaker 106 is a driver that, in accordance with one embodiment, covers about 2,000 Hz to 5,000 Hz. This speaker 106 may be included to enhance mid-frequency detail and clarity. While the performance of balanced armature speakers 106 has a tendency to attenuate between 5,000 Hz and 10,000 Hz, they do not cease functioning entirely and instead tend to exhibit a reduced output. Accordingly, while the performance of the balanced armature speaker 106 may decrease outside of its primary operating frequency, it can still help provide a more complete sound experience across a broad frequency band.

The dynamic speaker 108 is a driver that, in accordance with one embodiment, covers about 100 Hz to 10 kHz. This speaker 108 may be included to enhance richer low-frequency performance. Dynamic speakers 108 provide more relaxed and natural sound output at low frequencies, due at least in part to their larger diaphragm area.

The electrostatic speaker 110 is a driver that, in accordance with one embodiment, covers about 10,000 Hz to 14,000 Hz. The speaker 110 may be included to primarily handle higher frequencies. This can help supplement the balanced armature speaker 106 and dynamic speaker 108, which typically cannot adequately cover higher frequency ranges. The electrostatic speaker 110 can help to render high-frequency sounds clearer and more delicate.

The bone conduction speaker 112 is a driver that, in accordance with one embodiment, covers about 15 Hz to 1 kHz, and also responds well in the mid-to high-frequency range of 1 kHz to 10 kHz. The bone conduction speaker 112 performs significantly well in low-frequency ranges. As detailed further herein, the bone conduction speaker 112 drives cavity vibration, which in this implementation, transmits sound waves to the cochlea through cavity resonance. The collaborative work of the bone conduction speaker 112 with the other audio technologies helps to ensure excellent performance across a full frequency range.

Integration of bone conduction and air conduction is advantageous, and done with a particular organization within the outer shell 102 to help optimize performance, as detailed below. Bone conduction transforms sound waves into mechanical vibration, initially acting on the auricle and surrounding cartilage, then transmitting to the ossicles in the ear, and ultimately reaching the cochlea. This conduction method bypasses the eardrum, directly stimulating inner ear structures. Concurrently, air conduction transmits sound waves through air to the eardrum, providing a more conventional sound transmission method. The combination in the embodiment of FIGS. 1 and 2 creates a dual sound transmission pathway, offering a more immersive auditory experience unattainable by traditional headphones. This synergistic operation helps to achieve unprecedented levels of fidelity, sound experience, and user convenience/wearability in earphone design.

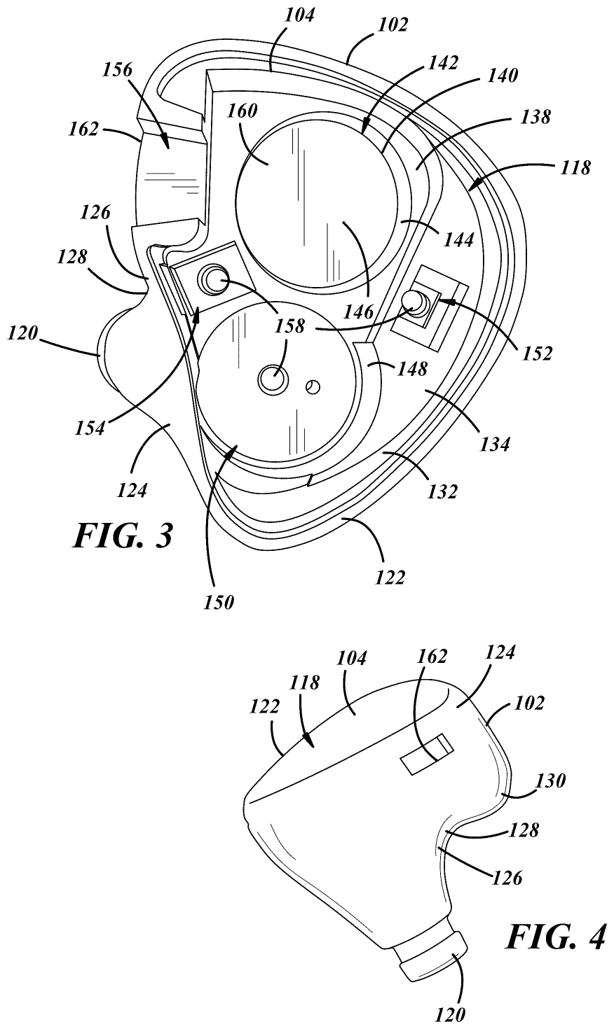

The integration of bone conduction, air conduction, and cavity vibration given the particular design of the shell as shown in FIGS. 3 and 4, helps to provide users with a more stereoscopic and dynamic audio experience. The bone conduction speaker 112 drives cavity vibration, transmitting sound waves to the cochlea through cavity resonance. By transmitting vibrations from the bone conduction speaker 112 to the interior of the outer shell body 104 of the earphone 100, the cavity's resonance effect further amplifies and enriches the sound, particularly enhancing low-and mid-frequency performance. Unlike traditional direct air conduction method, this design does not rely on external air transmission but achieves sound conduction through the strategic design of the internal cavity 118 of the outer shell body 104, delivering a more layered and dynamic auditory experience. This implementation retains the advantages of bone conduction while enhancing overall sound quality through optimized cavity design, allowing users to experience more immersive audio.

FIGS. 3 and 4 show the outer shell 102, which in this implementation, has a variable thickness outer shell body 104 which helps form the internal cavity 118 for the subcomponents of the earphone 100. The shell body 104 design and vibration amplification impact given the illustrated configuration can effectively improve mid to low frequency audio quality, resulting in fuller and more natural sound. This is challenging to achieve in traditional earphone designs, particularly in the reproduction of low-frequency effects.

Traditional bone conduction earphones generally place the speaker at the temple bone in front of the ears, transmitting sound through bone vibration. However, this design has several issues. Due to the ear-hook structure, it is challenging to ensure that the unit fits tightly against the bone. The sound quality can change significantly with slight changes in the wearing style. Traditional bone conduction earphones often struggle with mid and low frequencies as well. This is because the contact and vibration transmission between the speaker and the soft bone are not optimal, resulting in thin, unrealistic sound, especially in the low-frequency range.

In the illustrated embodiment, the bone conduction speaker 112 is installed inside the outer shell 102 rather than directly contacting the soft bone. This design uses the tight integration within the shell 102 to create an effect similar to a speaker through air and cavity vibration. Through the structural design of the outer shell body 104, the earphone 100 can effectively amplify mid and low frequencies, making the sound fuller and more natural. The vibration of the internal cavity's 118 sound is transmitted through the air, making the perceived sound richer and more powerful. The bone conduction speaker 112 vibrates through electrical current, and when it contacts the shell body 104, this vibration effect is amplified. This significantly enhances the mid-and low-frequency performance, improving the overall listening experience.

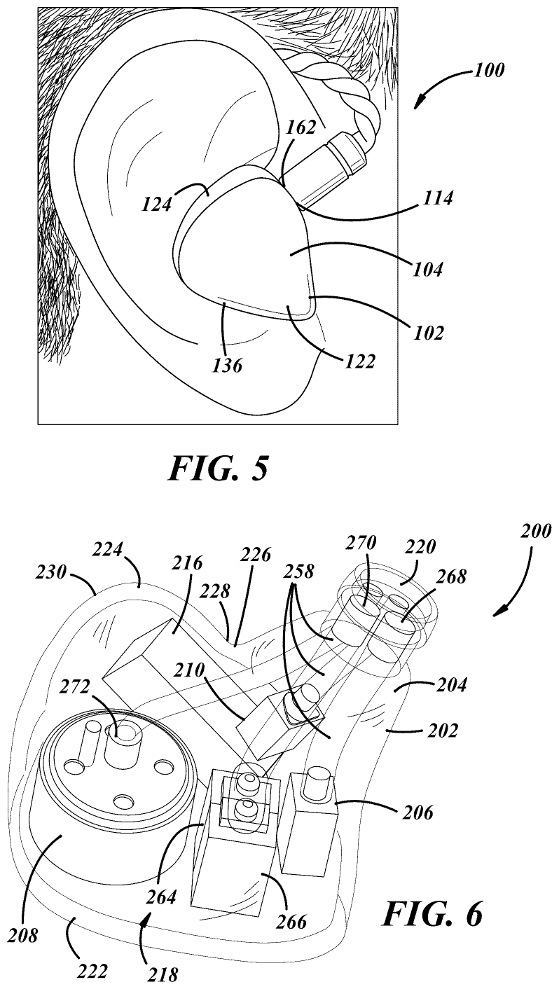

With particular reference to FIGS. 3 and 4, the outer shell body 104 extends from an insertion end 120 to an outer end 122. The insertion end 120 is configured to be situated in a user's ear, and the outer end 122 is configured to be situated more outside of the user's ear (see e.g., FIG. 5). A curvilinear outer surface 124 makes up a majority of the outer shell 102. The curvilinear outer surface 124 includes a concha contour surface 126. The concha contour surface 126 has a saddle-shaped, bowl-like configuration extending from the insertion end 120 to a base 128 and up to a crest 130 in the curvilinear outer surface 124. The bone conduction speaker 112 is configured to be located adjacent to the concha contour surface 126, or more particularly, directly adjacent (i.e., such that there is no other internal subcomponent between the bone conduction speaker 112 and the portion of the body 104 having the concha contour surface 126). As detailed herein, this particular arrangement helps with vibratory audio transmission.

Traditional bone conduction headphones are usually either completely located outside the ear, transmitting vibrations through the cheekbones or temporal bones, or fully inserted into the ear canal, directly acting on the walls of the ear canal. However, these designs may have limitations in wearing comfort, vibration transmission efficiency, and sound quality. The earphone 100, however, with the concha contour surface 126, cleverly utilizes the natural contours of the concha to achieve a more secure contact and more efficient vibration transmission. The concha is part of the outer ear, located in the recessed area inside the auricle, shaped like a small bowl near the entrance of the ear canal. It plays an important role in the transmission of sound waves, especially in spatial localization and directional perception of sound. The anatomical structure of the concha helps the user distinguish the source of sounds, particularly sounds coming from above, below, front, or back.

The curved structure of the concha provides sufficient surface area, allowing the bone conduction speaker 112 to fit snugly, unlike other devices that transmit vibrations only through the outer auricle or the inside of the ear canal. This design reduces wearing pressure and transmits more uniform vibrations through a larger contact area, thereby improving the efficiency of vibration energy transmission. The concha helps guide external sounds into the ear canal, acting like a sound wave receiver by reflecting and directing sound waves into the ear canal, enhancing the energy and clarity of sound.

In the illustrated embodiment, the vibrations of the bone conduction speaker 112 are transmitted to the cochlea through the following steps:
(1) Shell 102 Design: The headphone 100 shell 102 fits closely with the concha at the concha contour surface 126, and vibrations are transmitted from the bone conduction speaker 112 to the auricle through the shell body 104. The design of the shell 102 not only enhances physical contact with the ear but also amplifies the vibration effect through the cavity structure.
(2) Vibration Transmission to the Skull: Vibrations are transmitted to the skull's bones through the concha. Since the concha is close to a thinner area of the skull, it can effectively transmit vibrations to the temporal bone, ultimately reaching the cochlea of the inner ear.
(3) Bypassing the Eardrum: The core advantage of bone conduction technology is that it can bypass the outer and middle ear, directly acting on the inner ear. Vibrations stimulate the hair cells of the cochlea through the skull, triggering electrical signals that are ultimately perceived by the brain as sound.
(4) Multiple Transmission Paths: In addition to bone conduction, the earphone 100 also realizes the synergistic effect of air conduction and cavity resonance through the shell body 104. This not only enhances the clarity of sound but also makes the performance of low and mid frequencies fuller and more natural.

The design of the outer shell 102 fully considers the anatomy of the concha, not only achieving a snug fit for the bone conduction speaker but also designing cavities for air resonance to enhance sound quality. The design is ergonomic, with the shape of the shell 102 mimicking the concha, reducing sound quality fluctuations caused by changes in wearing position. Vibration optimization can also be enhanced. In some embodiments, the shell 102 material is specially designed, using photosensitive resin or other lightweight materials, to enhance the stability of vibration transmission and the consistency of sound quality while ensuring wearing comfort.

The concha not only plays a key role in the design of the earphone 100, but also has important functions itself. The concha helps with sound direction localization, helping us perceive the direction of sound sources. Different parts of the ear can reflect and refract sound in various ways, which is related to the frequency of sound waves, helping to identify the direction of sound sources, especially in vertical localization. The concha also helps with sound reflection and frequency adjustment. Before entering the ear canal, the concha reflects sound waves, altering their path. These reflections are more effective at certain frequencies, known as the pinna effect, affecting the perception of the sound spectrum characteristics and sources.

It has been experimentally shown that if one uses Blu Tack to block the concha, it will significantly affect the perception of the spatial origin of sounds. This blocking can obstruct directional perception. The reflective function of the concha is weakened, making it impossible to accurately capture sounds from different directions, especially vertically. The blocking can decrease sound clarity. The concha enhances sounds at specific frequencies; blocking it will weaken sounds at certain frequencies, reducing auditory clarity. The blocking can also impair the binaural effect, as the concha affects the brain's ability to locate sounds through the time difference of sound waves between the left and right ears, especially in the vertical direction.

Compared to traditional bone conduction devices that are completely external or inserted into the ear canal, the illustrated design provides multi-point vibration transmission through the concha position, thereby reducing vibration loss, improving wearing comfort, and enhancing mid-and low-frequency performance. The concha is directly connected to the temporal bone, with minimal vibration energy loss and high transmission efficiency. The natural curves of the concha provide a stable wearing experience, reducing pressure and discomfort from long-term wear. Through cavity resonance design in the internal cavity 118, the transmission of mid and low-frequency ranges is richer and more natural, overcoming the poor low-frequency performance of traditional bone conduction headphones.

The earphone 100 combines the anatomical features of the concha and acoustic principles, allowing the bone conduction speaker 112 to transmit sound to the cochlea more efficiently and comfortably via the concha contour surface 126, delivering a superior auditory experience. By fully utilizing the concha's key role in sound capture, transmission, and localization, the illustrated bone conduction headphones 100 have significant improvements in both performance and comfort.

The shell body 104 is configured to help enhance the vibratory transmission between the bone conduction speaker 112 and the concha contour surface 126, while orienting the internal subcomponents more efficiently to handle the multi-speaker functionality. As shown in FIGS. 2 and 3, the internal cavity 118 is generally defined by an inner component retaining wall 132 that leads to a first speaker recess base surface 134. A second speaker recess base surface 136 is also included, which helps to seat the transformer 116 in an advantageous location for operation with the electrostatic speaker 110 that is located partly between the bone conduction speaker 112 and the dynamic speaker 108. The first speaker recess base surface 134 and the second speaker recess base surface 138 are each located along offset planes from the outer back cover 136 at the outer end 122 of the outer shell body 104 (see e.g., FIG. 5). This can help with orienting the internal subcomponents to enhance the vibratory transmission through to the concha contour surface 126.

As shown more particularly in FIG. 3, the internal cavity 118 includes a bone conduction shell body portion 140 that creates a subspace or smaller bone conduction cavity 142 for housing the bone conduction speaker 112. The bone conduction shell body portion 140 includes an annular side wall 144 and a base wall 146 adjoining the annular side wall. The base wall 146 is also located along an offset plane from the speaker recess base surfaces 134, 138. The annular side wall 144 is located between the base wall 146 and the second speaker recess base surface 138. A height of the annular side wall 144 is less than a height of the bone conduction speaker 112, as shown more particularly in FIGS. 1 and 2, which results in the side wall of the bone conduction speaker 112 only partially surrounded by the bone conduction shell body portion 140, which also has the potential to impact vibratory transmission. A common speaker/transformer side wall 148 extends between the second speaker recess base surface 138 and the first speaker recess base surface 134. This wall 148 helps to define a dynamic speaker cavity 150. Other cavities may also include a balanced armature cavity 152, an electrostatic cavity 154, and a signal interface cavity 156, to cite a few examples.

Each of the cavities 150, 152, 154 have a transmission channel 158 that extends through the body 104 to the insertion end 120. However, the bone conduction cavity 142 does not have a transmission channel 158, and instead includes a continuous vibratory surface 160 for the base wall 146. The continuous vibratory surface 160 is configured to directly oppose the concha contour surface 126 along the shell body 104, which can help transmit vibration through the bowl-like or saddle-like shape of the concha contour surface to the concha of a user. The continuous vibratory surface 160 is generally planar, without gaps or openings. The diaphragm of the bone conduction speaker 112 is configured to face directly toward the base wall 146 / continuous vibratory surface 160. This arrangement helps amplify the vibratory effect through both air conduction and cavity resonance through the outer shell body 104.

In some embodiments, portions of the earphone 100 are manufactured using an additive manufacturing method, such as three-dimensional printing. In an advantageous implementation, the outer shell body 104 is 3-D printed. This allows for the size and shape of the outer shell 102 to be customized to a user. More particularly, the earphone 100 may be designed to more closely or accurately mimic the shape of the user's concha at the concha contour surface 126. Other manufacturing methods are certainly possible.

With reference to FIGS. 4, 5, and 8, an opening 162 in the curvilinear outer surface 124 of the outer shell 102 may be included to accommodate the signal interface 114. This small rectangular opening 162 is the reserved installation position for the signal interface 114, specifically for the wired version of the headphones. The opening 162 allows the signal interface to be securely embedded into the earphone shell 102, ensuring the firmness of the cable connection and the reliability of signal transmission. The embodiment illustrated in FIG. 5 has a wired signal interface, but it is possible to have a wireless connection in other embodiments. With a wired version, the signal interface 114 is used to connect the headphones to audio sources via physical cables, such as phones, music players, or professional audio equipment. This interface 114 connects to the internal circuit board and audio units of the earphone 100, ensuring stable transmission of audio signals. Users can replace cables of different materials according to personal preferences, such as pure copper, silver-plated, or other high-conductivity materials. Different cables may subtly affect sound quality, meeting the needs of audiophiles and professional users for fine-tuning audio performance. With a wireless version, the physical signal interface 114 may be eliminated and it may be replaced with an integrated wireless module, such as Bluetooth or other wireless transmission technologies. With such an embodiment, audio signals would be transmitted to the headphones wirelessly, without the need for physical cable connections. This arrangement has the potential to provide greater mobility and convenience, suitable for daily use and sports scenarios.

FIGS. 5 and 8 also illustrate how the earphone 100 cooperates with the anatomy of a user. Unlike typical bone conduction headphones that have the bone conduction speaker more fully inserted into the ear or outside of the ear entirely, the earphone 100 has the insertion end 120 inserted into the ear canal and the outer end 122 outside of the ear. This helps orient the bone conduction speaker 112 and the concha contour surface 126 directly adjacent the concha 127 of the user's ear 129, without intervening subcomponents.

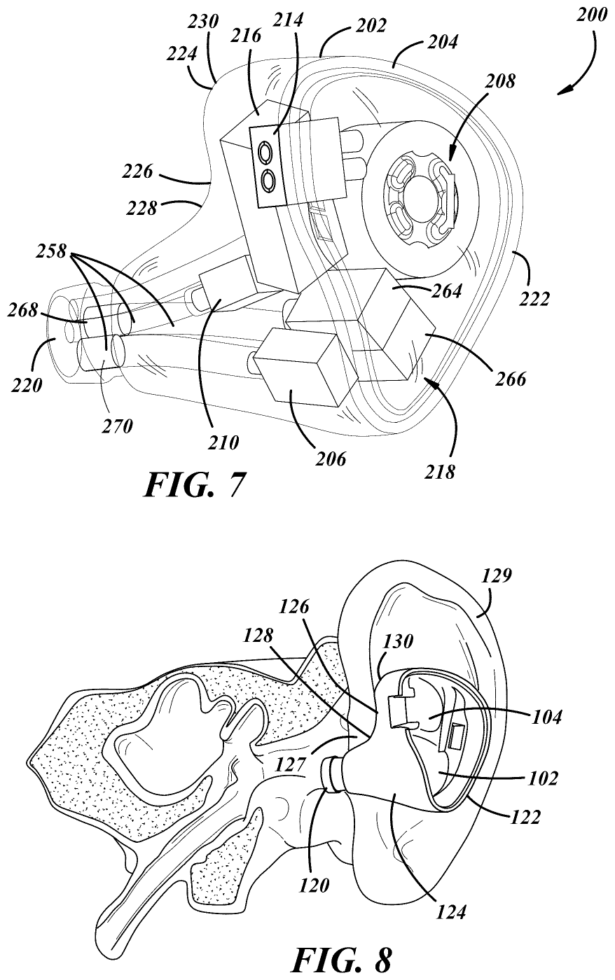

FIGS. 6 and 7 show another embodiment of an earphone 200 (wherein like reference numerals denote like features). This embodiment does not have a bone conduction speaker, and instead includes a second balanced armature speaker 264 and a third balanced armature speaker 266. In this embodiment, the first balanced armature speaker 206 cooperates with a transmission channel 258, and both the second and third balanced armature speakers 264, 266 cooperate with a single other transmission channel 258. The number of balanced armature units 206, 264, 266 is increased by two in this implementation to cover a wider frequency range, and can enhance mid-to high-frequency performance, as well as to at least partially compensate for low-frequency performance and specific frequency bands. This implementation also includes filters 268, 270, 272 which may be included in either embodiment to provide additional sound tuning.

It is to be understood that the foregoing description is of one or more preferred example embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” and “such as,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all the following: “A”; “B”; “C”; “A and B”; “A and C”; “B and C”; and “A, B, and C”.

1. An earphone, comprising:
an outer shell having a concha contour surface; and
a bone conduction speaker located at least partially in the outer shell, wherein the bone conduction speaker is located adjacent the concha contour surface.

2. The earphone of claim 1, further comprising an electrostatic speaker, a dynamic speaker, and a balanced armature speaker.

3. The earphone of claim 2, wherein each of the bone conduction speaker, the electrostatic speaker, the dynamic speaker, and the balanced armature speaker are located wholly within the outer shell.

4. The earphone of claim 1, wherein the outer shell has an outer shell body extending from an insertion end to an outer end.

5. The earphone of claim 4, wherein the outer shell body has an inner component retaining wall that leads to a speaker recess base surface.

6. The earphone of claim 5, wherein the speaker recess base surface is located along an offset plane from a plane defined by the outer shell at the outer end of the outer shell body.

7. The earphone of claim 5, wherein the outer shell body has a bone conduction shell body portion that extends from the speaker recess base surface.

8. The earphone of claim 7, wherein the bone conduction shell body portion comprises a side wall that at least partially surrounds the bone conduction speaker.

9. The earphone of claim 8, wherein the bone conduction shell body portion has a base wall adjoining the side wall.

10. The earphone of claim 9, wherein the side wall is an annular side wall having a height that is less than a height of the bone conduction speaker.

11. The earphone of claim 9, wherein the base wall is a continuous vibratory surface.

12. An earphone, comprising:
an outer shell;
an electrostatic speaker located at least partially within the outer shell;
a dynamic speaker located at least partially within the outer shell; and
a plurality of balanced armature speakers located at least partially within the outer shell.

13. The earphone of claim 12, further comprising a bone conduction speaker located at least partially within the outer shell.

14. The earphone of claim 13, wherein the bone conduction speaker is located adjacent a concha contour surface in the outer shell.

15. The earphone of claim 12, wherein two or more balanced armature speakers of the plurality of balanced armature speakers cooperate with a single transmission channel.

16. A method of using an earphone, the earphone comprising a bone conduction speaker located at least partially within an outer shell, the method comprising the steps of:
transferring vibration from the bone conduction speaker to the outer shell; and
transferring vibration from the outer shell to a concha of a user.

17. The method of claim 16, wherein the bone conduction speaker is located at least partially within a bone conduction shell body portion to amplify a vibratory effect during either of the transferring vibration steps.

18. The method of claim 17, wherein the vibratory effect is amplified through both air conduction and cavity resonance through the outer shell.
